(19) United States
(12) Patent Application Publication
(10) Pub. No.: US 2022/0404987 A1
(43) Pub. Date: Dec. 22, 2022

(54) STORAGE SYSTEM, STORAGE CONTROL DEVICE, AND STORAGE CONTROL METHOD

(71) Applicant: FUJITSU LIMITED, Kawasaki-shi (JP)

(72) Inventors: Ichirou SAKUMA, Yokohama (JP); Yasuo NOGUCHI, Kawasaki (JP)

(73) Assignee: FUJITSU LIMITED, Kawasaki-shi (JP)

(21) Appl. No.: 17/686,833

(22) Filed: Mar. 4, 2022

(30) Foreign Application Priority Data
Jun. 21, 2021 (JP) 2021-102693

(51) Int. Cl. G06F 3/06

(52) U.S. Cl. CPC G06F 3/0622; G06F 3/0655; G06F 3/0689

(57) ABSTRACT

A storage system performs storage tiering including a first storage device and a second storage device. The first storage device that stores data, the second storage device that stores data that is stored in the first storage device and elapses for a predetermined period of time. A storage control device that stores data in time series in the second storage device, reads the time-series data at a predetermined timing, and reorganizes the read data for each key to store the reorganized data in the second storage device and read the reorganized data from the second storage device when the data is read by the key.

### CROSS-REFERENCE TO RELATED APPLICATION

This application is based upon and claims the benefit of priority of the prior Japanese Patent Application No. 2021-102693, filed on Jun. 21, 2021, the entire contents of which are incorporated herein by reference.

### FIELD

The embodiments discussed herein are related to a storage system, a storage control device, and a storage control method.

### BACKGROUND

There is a storage tiering solution that combines online storage and offline storage.

In the storage tiering solution, most recent data (for example, one half to one year after being created) is stored in an online storage, and previous data is moved to an inexpensive offline storage in some cases. In this way, it is possible to achieve a lower total cost of ownership (TCO) than that in a case where all data are stored in the online storage. In order to ensure data integrity, the same data may be stored in two or more offline media.

Japanese Laid-open Patent Publication No. 2020-021396, Japanese Laid-open Patent Publication No. 6-282479, and Japanese Laid-open Patent Publication No. 6-332768 are disclosed as related art.

### SUMMARY

According to an aspect of the embodiments, a storage system that performs storage tiering, the storage system includes: a first storage device that stores data; a second storage device that stores data that is stored in the first storage device and elapses for a predetermined period of time; and a storage control device that stores data in time series in the second storage device, reads the time-series data at a predetermined timing, and reorganizes the read data for each key to store the reorganized data in the second storage device and read the reorganized data from the second storage device when the data is read by the key.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 a block diagram schematically illustrating a configuration example of a storage system as a related example;

FIG. 2 is a block diagram for describing an operation example of the storage system illustrated in FIG. 1;

FIG. 3 is a diagram for describing an arrangement example of data in a plurality of tapes of the storage system illustrated in FIG. 1;

FIG. 4 is a diagram for describing a change in a pool of a storage destination for each creation time of data in the storage system illustrated in FIG. 1;

FIG. 5 is a diagram describing an arrangement example of data for each date of data creation in a tape of the storage system illustrated in FIG. 1;

FIG. 6 is a block diagram schematically illustrating a configuration example of a storage system according to an embodiment;

FIG. 7 is a block diagram schematically illustrating an example of a hardware configuration of an offline storage controller illustrated in FIG. 6;

FIG. 8 is a table exemplifying a management list in the storage system illustrated in FIG. 6;

FIG. 9 is a table exemplifying a management list obtained by reorganizing data in the storage system illustrated in FIG. 6;

FIG. 10 is a diagram for describing an arrangement example of data in a plurality of tapes after reorganizing data in the storage system illustrated in FIG. 6;

FIG. 11 is a block diagram illustrating states of tapes in libraries in which data is being organized;

FIG. 12 is a flowchart for describing a process of writing to a time-series tape in a controller illustrated in FIG. 6;

FIG. 13 is a flowchart for describing details of a process of moving to an offline storage illustrated in FIG. 12;

FIG. 14 is a flowchart for describing a process of reorganizing data in the offline storage controller illustrated in FIG. 6;

FIG. 15 is a flowchart for describing a first detailed example of the process of reorganizing data in the offline storage controller illustrated in FIG. 6;

FIG. 16 is a flowchart for describing a second detailed example of the process of reorganizing data in the offline storage controller illustrated in FIG. 6; and

FIG. 17 is a flowchart for describing a process of reading data in the offline storage controller illustrated in FIG. 6.

### DESCRIPTION OF EMBODIMENTS

In the storage tiering solution, data movement to the offline storage is performed daily or monthly after a certain period of time (for example, one year) elapses from the date and time of creation or the date and time of last update of data. In the order of data movement, data is moved from the oldest in order of data creation date and time, or last update date and time. As a result, the data is stored in chronological order in the offline medium.

Meanwhile, when reading of old data is done in chronological order, there is no problem; however, when it is desired to extract and read only data containing a specific key, the data is distributed to a plurality of offline media, resulting in media exchanging times, and thus it may take some time to read the data. In a case where the offline medium is a magnetic tape, when data is distributed in one offline medium, a large number of locations (positioning) occur, and thus it may take some time to read the data.

In one aspect, it is an object to increase the speed of a reading process.

### [A] Related Example

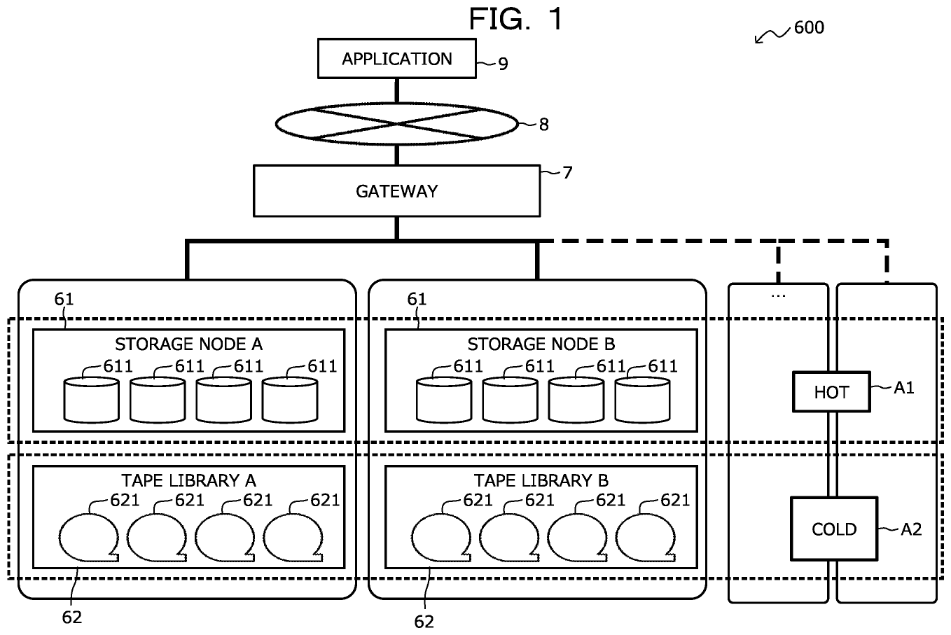

FIG. 1 a block diagram schematically illustrating a configuration example of a storage system 600 as a related example.

A storage system 600 has a function of a storage tiering solution, and includes a plurality of storage nodes 61 (storage nodes A, B, . . . ), tape libraries 62 (tape libraries A, B, . . . ), and a gateway 7.

The gateway 7 has a server function, divides and distributes data transmitted from an application 9 via a network 8, and writes the divided and distributed data to disks 611 of the storage nodes 61. Meanwhile, when there is a data read request from the application 9 via the network 8, the gateway 7 collects data distributed over the disks 611 of the storage nodes 61, combines the data, and returns the combined data to the application 9.

Each of the storage nodes 61 has a server function and includes a plurality of (four in the example illustrated in FIG. 1) disks 611 in which hot data having a high data access frequency is stored as indicated by reference sign A1. By using the management software, the storage node 61 manages the tape library 62 coupled to the storage node 61.

Each of the tape libraries 62 includes a plurality of (four in the illustrated example) tapes 621 in which cold data having a low data access frequency is stored as indicated by reference sign A2.

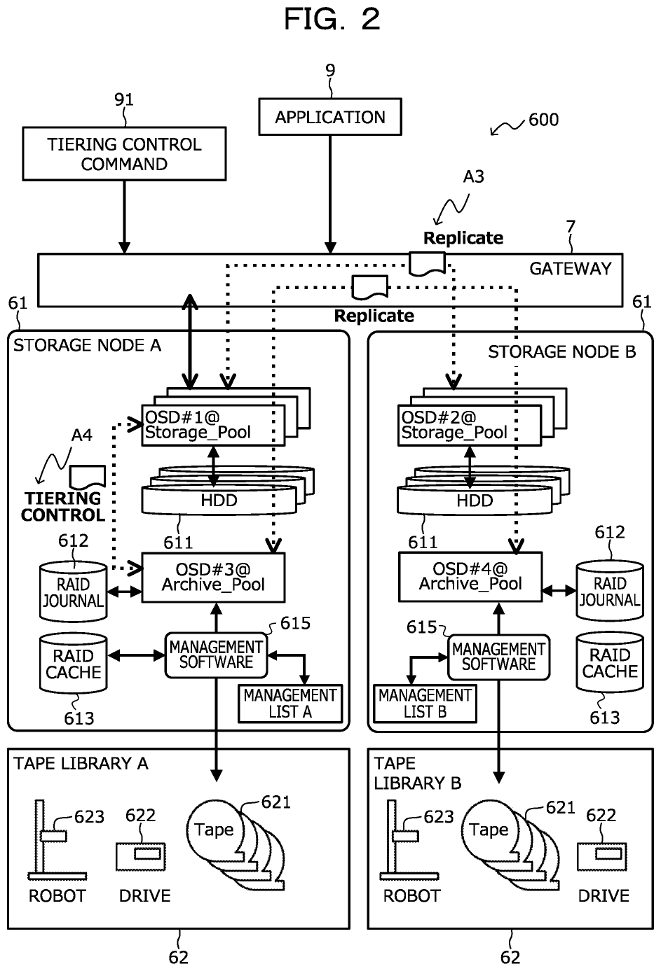

FIG. 2 is a block diagram for describing an operation example of the storage system 600 illustrated in FIG. 1.

Data put (written) from the application 9 is distributed and stored in hard disk drives (HDDs), which are object storage devices (OSDs) of Storage_Pool built in each storage node 61, through the gateway 7.

By a replicate process indicated by reference sign A3, a duplicate is simultaneously created in another OSD for data integrity. Alternatively, parity (erasure coding) may be created for data integrity.

According to a set policy (for example, data for which one year elapses after creation is archived), by a tiering control command as indicated by reference sign A4, the data that is distributed and stored in Storage_Pool is combined in the original form and moved to Archive_Pool. Archive_Pool is a logical pool managed by a management software 615, and actually includes a RAID cache 613 and a tape library 62, and data written to the pool is finally written to the tapes 621. RAID is an abbreviation for redundant arrays of inexpensive Disks or redundant arrays of independent disks.

The tape library 62 contains the tapes 621, a plurality of cells (not illustrated) for storing the tapes 621, a robot mechanism 623 for moving the tapes 621, and a tape drive 622 for recording and reading data to and from the tapes 621.

A RAID journal 612 stores an update history of the data in Archive_Pool.

The management software 615 includes a management list (management lists A and B in the example illustrated in FIG. 2) for managing which data is written on which a tape 621. Similar to the case of Storage_Pool, also in the case of Archive_Pool, a duplicate is created for data integrity by the replicate process.

On the other hand, in a case where there is a GET (reading) request from the application 9, the gateway 7 proceeds to read Archive_Pool, and in response to the reading, the management software 615 reads corresponding data from the tape 621 and transmits the data to the application 9.

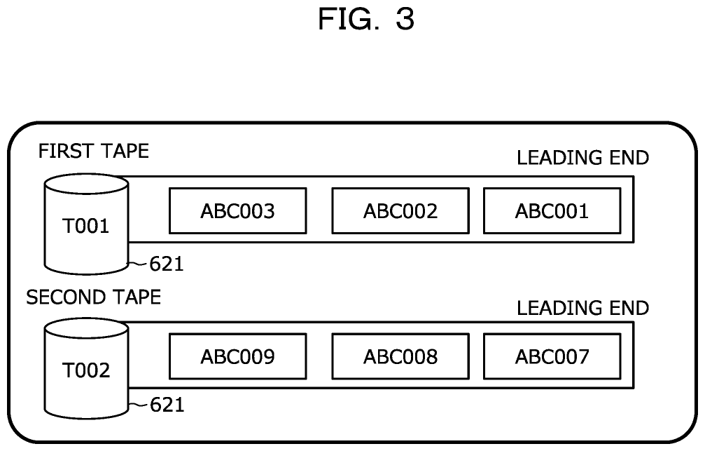

FIG. 3 is a diagram for describing an arrangement example of data in a plurality of tapes 621 of the storage system 600 illustrated in FIG. 1.

For example, in a case where data is added to a storage pool every day, an operation is conceivable in which data for which one year elapses (data stored in the storage pool on the same day of the same month in the previous year) is moved to an archive pool. As a result, the data is written to the tapes 621 in chronological order. For example, in a case where the amount of data for one month corresponds to the capacity of one tape, data for the most recent one year is present in the storage pool, and thus data is stored in time series on 48 tapes 621 (twelve (in five years) times four (years) equals 48).

In the example illustrated in FIG. 3, data ABC001, ABC002, ABC003, . . . are stored in order from the leading end of a first tape 621 indicated by T001. Data ABC007, ABC008, ABC009, . . . are stored in order from the leading end of a second tape 621 indicated by T002.

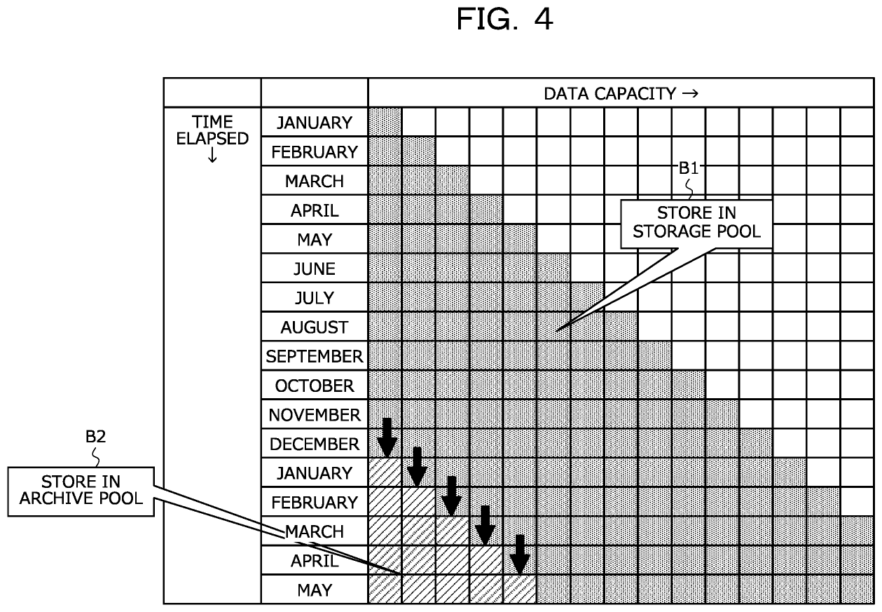

FIG. 4 is a diagram for describing a change in a pool of a storage destination for each creation time of data in the storage system 600 illustrated in FIG. 1.

For example, in a case where there is a patient who visits a hospital once every month in a database of medical records of patients in the hospital, in order to view data for five years of the patient, data for one year in a storage pool and data distributed to 48 tapes for the remaining four years in an archive pool have to be read.

As indicated by reference sign B1 in the example illustrated in FIG. 4, data for 12 months from January to December, February to the next January, March to the next February, and so on are stored in the storage pool. As indicated by reference sign B2, the data for which 12 months have elapsed since the storage of the storage pool are sequentially stored in the archive pool.

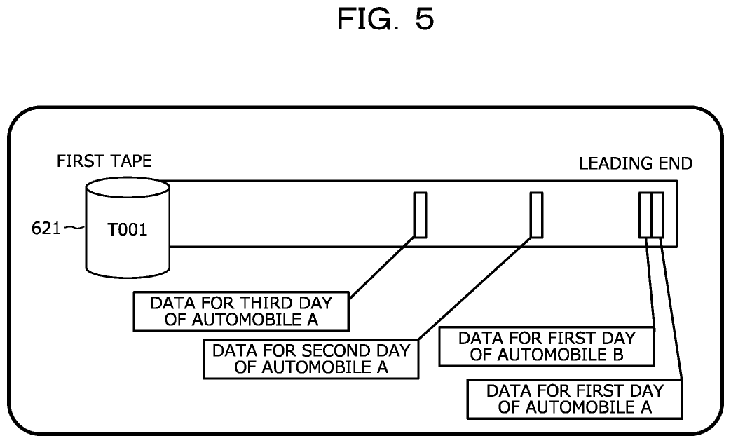

FIG. 5 is a diagram describing an arrangement example of data for each date of data creation in the tape 621 of the storage system 600 illustrated in FIG. 1.

For receiving and storing controller area network (CAN) data about an automobile used daily, data about a certain automobile for one day are collectively written to the tape 621, but data about another automobile for one day are also recorded. Even when data for one month of all automobiles is stored in one tape, when one month is 30 days, data about a certain automobile is distributed at 30 locations over the tape, and 48 tapes 621 have to be read in order to view data for five years.

In the example illustrated in FIG. 5, in the first tape 621 indicated by T001, first data about an automobile A, first data of about automobile B, second data about the automobile A, and third data about the automobile A are stored in this order from the leading end, and data about the automobiles A and B are mixed.

### [B] Embodiment

An embodiment will be described below with reference to the drawings. The embodiment described below is merely illustrative and is not intended to exclude employment of various modification examples or techniques that are not explicitly described in the embodiment. For example, the present embodiment may be implemented by variously modifying the embodiment without departing from the gist of the embodiment. Each of the drawings is not intended to indicate that only the elements illustrated in the drawing are included. Thus, other functions or the like may be included.

The same reference sign denotes the same or similar elements in the drawings, so that the description thereof is omitted below.

### [B-1] Configuration Example

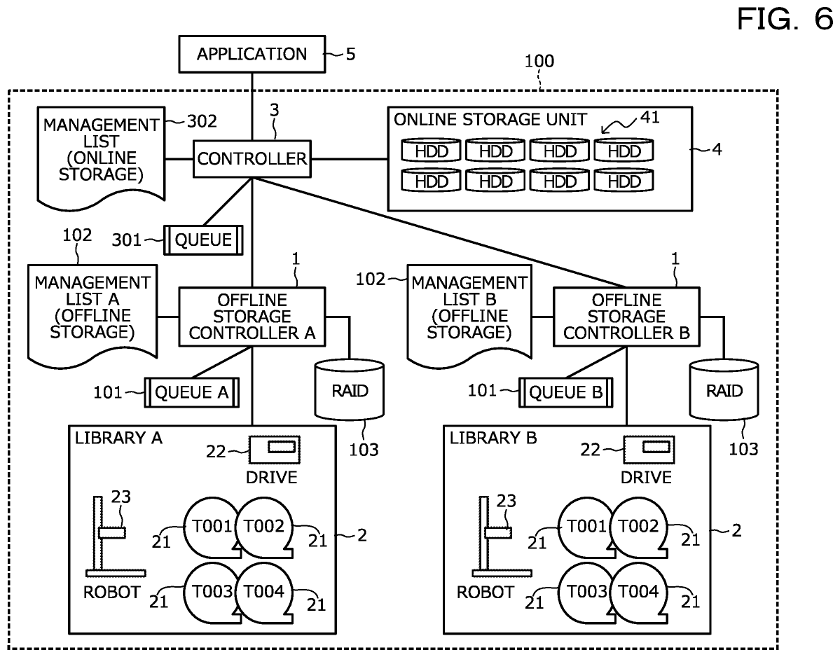

FIG. 6 is a block diagram schematically illustrating a configuration example of a storage system 100 according to an embodiment.

The storage system 100 has a function of a storage tiering solution, and includes two offline storage controllers 1 (offline storage controllers A and B), two libraries 2 (libraries A and B), a controller 3, and an online storage unit 4.

The controller 3 temporarily accumulates commands transmitted from an application 5 in a queue 301 and sequentially processes the commands. When data is transmitted from the application 5, the data is written in the online storage unit 4. The controller 3 manages the data written in an online storage unit 4 by using an online storage management list 302. By referring to the management list 302, the controller 3 transmits, to the offline storage controller 1, data for which a certain period of time has elapsed after being written to the online storage unit 4. The online storage unit 4 may include a plurality of HDDs (or solid-state drives (SSDs)) 41.

The offline storage controller 1 is an example of a storage control device, and temporarily accumulates commands received from the controller 3 in queues 101 (queues A and B), and sequentially processes the commands. Data is temporarily written to RAIDs 103, and then written to the libraries 2. The offline storage controller 1 manages data written to libraries 2 by management lists 102 (management lists A and B) of the offline storage.

Each of the libraries 2 includes a plurality of tapes 21 (T001 to T004), a drive 22, and a robot 23. Each tape 21 is transported to the drive 22 by the robot 23, and reading and writing are executed by the drive 22.

The offline storage controller 1 stores data in time series in the library 2, reads the time-series data at a predetermined timing, and reorganizes the read data for each key to store the reorganized data in the library 2 and read the reorganized data from the library 2 when data is read by the key.

The offline storage controller 1 may temporarily copy all the time-series data from the tape 21 in the library 2 to the online storage unit 4 at the predetermined timing. The offline storage controller 1 may reorganize all the time-series data in the online storage unit 4 for each key to store the reorganized data in a new tape 21 in the library 2.

The offline storage controller 1 may temporarily copy, from the tape 21 in the library 2 to the online storage unit 4, data to be stored on a new tape 21 in the library 2 among the time-series data, at the predetermined timing. The offline storage controller 1 may reorganize the data to be stored in the online storage unit 4 for each key to store the reorganized data on the new tape 21.

When data to be read is not stored in the online storage unit 4, the offline storage controller 1 may read the data to be read from the library 2.

When the number of times of replacement of the tapes 21 with the drive 22 in the library A is equal to or less than the number of times of replacement of the tape 21 with the drive 22 in the library B, the offline storage controller A may read data from the library A. By contrast, when the number of times of replacement of the tapes 21 with the drive 22 in the library A is greater than the number of times of replacement of the tape 21 with the drive 22 in the library B, the offline storage controller B may read data from the library B.

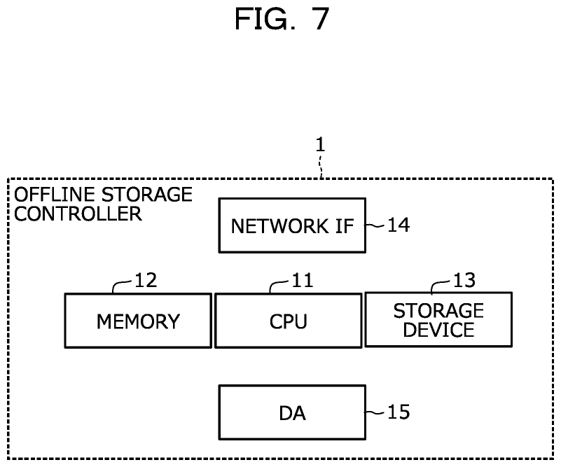

FIG. 7 is a block diagram schematically illustrating an example of a hardware configuration of the offline storage controller 1 illustrated in FIG. 6.

The offline storage controller 1 includes a CPU 11, a memory 12, a storage device 13, a network interface (IF) 14, and a device adaptor (DA) 15. The controller 3 may have the same hardware configuration as that of the offline storage controller 1 as well.

The memory 12 is, for example, a storage device that includes a read-only memory (ROM) and a random-access memory (RAM). The RAM may be, for example, a dynamic RAM (DRAM). Programs such as a basic input/output system (BIOS) may be written in the ROM of the memory 12. The software program in the memory 12 may be loaded and executed by the CPU 11 as appropriate. The RAM of the memory 12 may be used as a primary recording memory or a working memory.

The storage device 13 is, for example, a device that stores data enabled to be read and written, and may be, for example, an HDD, an SSD, or a storage class memory (SCM).

The network IF 14 is an interface device for coupling the offline storage controller 1 to a network and communicating with the controller 3 and an external device (not illustrated) via the network. As the network IF 14, for example, various interface cards corresponding to the standard of the network such as wired local area network (LAN), wireless LAN, and wireless wide area network (WWAN) may be used.

The DA 15 is an interface for communicably coupling the offline storage controller 1 and the library 2, and is, for example, a serial attached SCSI (SAS) adapter or a fiber channel (FC) adapter.

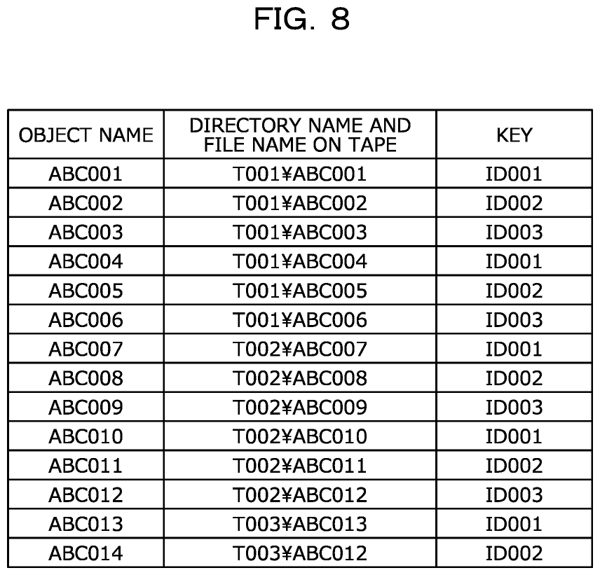

FIG. 8 is a table exemplifying the management list 102 in the storage system 100 illustrated in FIG. 6.

At the time of writing data to the tape 21, keys (for example, a patient ID, a vehicle ID, and a vehicle model) used at the time of grouping data may be recorded in the management list 102. The key may be recorded as metadata of an object or may be recorded as part of a file name to be written over the tape 21.

In the example illustrated in FIG. 8, ABC001 to ABC014 are recorded as “OBJECT NAME”. T001 [symbol] ABC001 to T001 [symbol] ABC006, T002 [symbol] ABC007 to T002 [symbol] ABC012, and T003 [symbol] ABC013 and T003 [symbol] ABC014 are recorded as “DIRECTORY NAME AND FILE NAME ON TAPE”. Further, ID001 to ID003 are recorded as “KEY”.

“T001”, “T002”, and “T003” represent media of the tapes 21. This example indicates that the data “ABC001”, “ABC002”, “ABC003”, “ABC004”, “ABC005”, and “ABC006” are written to the same tape 21 “T001”.

Since data is written to the tape 21 in the order of data generation, data having the same key is distributed to a plurality of tape media as illustrated in FIG. 8 when one year elapses after writing the data to the archive pool, for example.

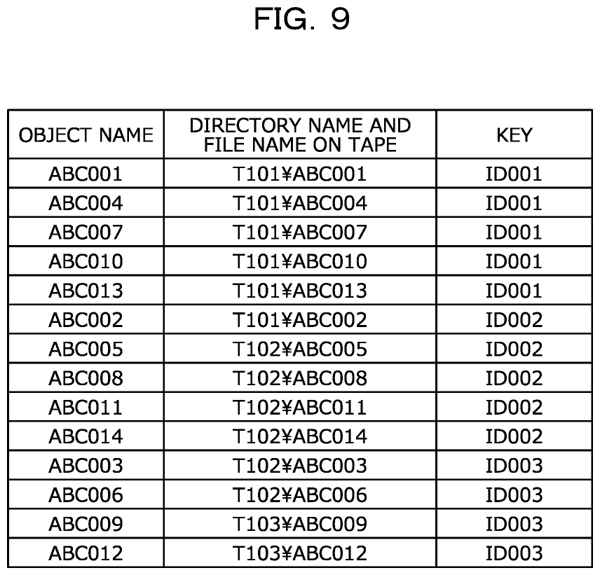

FIG. 9 is a table exemplifying a management list obtained by reorganizing data in the storage system 100 illustrated in FIG. 6.

In FIG. 9, an example of the management list 102 is illustrated in which, in the tape library B in the state illustrated in FIG. 8, data is read from the T001 to T003 tapes 21 in the key order and is written to the new T101 to 103 tapes 21.

Rearrangement by the grouping is performed only on the replica part (the library B) of the archive pool, and the original time-series data remains on the library A, and thus, for example, data in chronological order such as “data about all patients who visited 15 months ago” may be immediately read.

In the example illustrated in FIG. 9, the keys are sorted in the order of “ID001”, “ID002”, and “ID003” and written on T101 to 103 tapes 21.

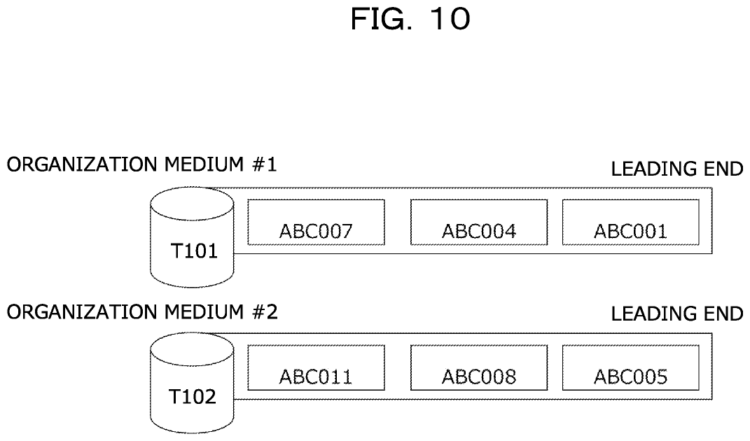

FIG. 10 is a diagram for describing an arrangement example of data in the plurality of tapes 621 at that time.

In the example illustrated in FIG. 10, in accordance with the management list after reorganization illustrated in FIG. 9, data ABC001, ABC004, ABC007, . . . are stored as organization media #1 in order from the leading end of the first tape 21 indicated by T101. Data ABC005, ABC008, ABC011, . . . are stored as organization media #2 in order from the leading end of the second tape 21 indicated by T102.

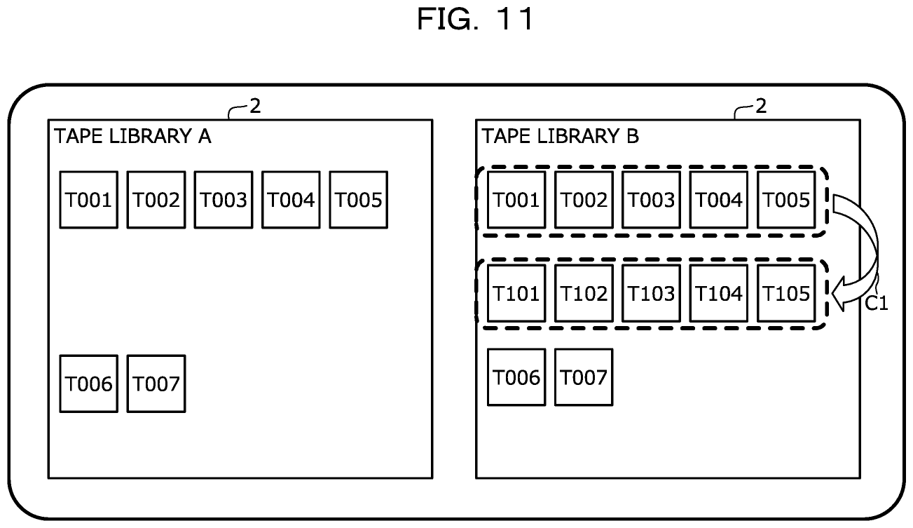

FIG. 11 is a block diagram illustrating states of tapes 21 in the libraries 2 in which data is being organized.

In FIG. 11, states of the tapes 21 in the libraries 2 while data is being organized are illustrated. As indicated by reference sign C1, at a stage where time-series data are recorded to the T001 to T005 in the library A and the library B, creation of T101 to T105 where T001 to T005 is organized for each key starts in the library B. During the reorganizing, time-series data increases and is stored as T006, T007, . . . . After all the rearrangement is completed, data for T001 to T005 in the library B becomes unnecessary, and thus the tape 21 is formatted and reused.

For example, in a case where the T103 tape 21 is damaged and becomes unreadable, the data written in T103 may be specified from the management list B, and T103 may be restored by organizing the data from the T001 to T005 tapes 21 in the library A.

As a timing at which the reorganizing of the data is performed, the following case (1) to (5) may be considered.

(1) A case of periodic time (once a year or the like), or user instruction

(2) A case where the tape replacement is required n times or more when reading for one key

(3) A case where there are n or more discontinuities over one tape when reading for one key

(4) A case where there are n or more media in which data is aggregated in the management list B and written in time series, and a required time exceeds a predetermined time (for example, eight hours at night) allowed for reading.

An example of the case (4) is a case where all records of a certain patient are acquired in a hospital,
tapes with one piece of time-series data are generated every month, and the number of tapes: n,
time taken to read a piece of data: A minutes,
average time to replace one volume of tape 21: B minutes, and
time to be positioned at the leading end of data: C minutes, and
   assuming that the average number of times one patient visits the hospital in a year is once a month, then, a time of n*(B+C+A) has to be taken to read data included in the time-series tape, and this does not end in eight hours at night

(5) A case where replacement of the tapes 21 is predicted to be performed n number of times or more from the past reading tendency, or alternatively, in a case where there is a patient for whom all data have been read, the data may be recorded on another tape 21 and may be sequentially reorganized.

As an organizing method, there is a method in which all of n pieces of time-series data are returned to the storage pool and are reorganized for each key and written on the tape 21, which may demand a large storage pool.

Accordingly, a free space of the storage pool for one volume of tape is secured, and time-series data is read for one volume of tape, and then the keys are grouped into n groups and the groups are separately written to each tape 21. In this way, it is possible to reorganize all the n pieces of time-series data while saving the capacity of the storage pool.

Alternatively, there is a method in which grouping of keys is performed in advance, data the reorganized tape 21 has to take is read from the time-series tape 21, and the read data is written on the reorganized tape 21. In this case, since the reorganizing key may be selected in advance, it is possible to preferentially collect data.

### [B-2] Operation Example

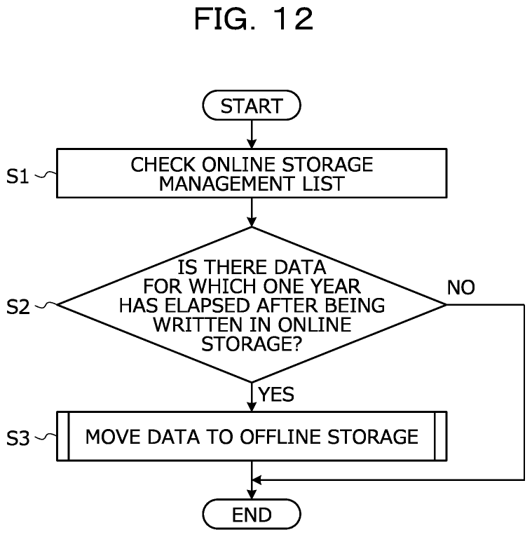

A process of writing to the time-series tape 21 in the controller 3 illustrated in FIG. 6 will be described with reference to a flowchart (step S1 to S3) illustrated in FIG. 12.

The controller 3 checks the online storage management list 302 (step S1).

The controller 3 determines whether or not there is data for which one year has elapsed after being written in the online storage unit 4 (step S2).

If there is no data for which one year has elapsed (see NO the route in step S2), the process of writing to the time-series tape 21 ends.

On the other hand, when there is data for which one year has elapsed (see the YES route in step S2), the controller 3 moves the data to the offline storage (step S3). Then, the process of writing to the time-series tape 21 ends.

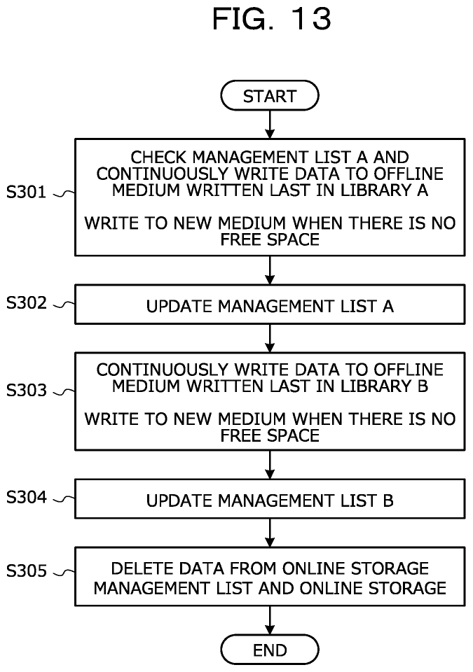

Details of the process of moving to the offline storage illustrated in FIG. 12 will be described with reference to a flowchart (step S301 to S305) illustrated in FIG. 13.

The offline storage controller A checks the management list A, and continuously writes the data to the offline medium (the tape 21) written last in the library A (step S301). When there is no free space to continuously write in the offline medium, the offline storage controller A writes the data to a new offline medium.

The offline storage controller A updates a management list A (step S302).

The offline storage controller B checks the management list B, and continuously writes the data to the offline medium (the tape 21) written last in the library B (step S303). When there is no free space to continuously write in the offline medium, the offline storage controller B writes the data to a new offline medium.

The offline storage controller B updates the management list B (step S304).

The controller 3 deletes the data from the online storage management list 302 and the online storage unit 4 (step S305). Then, the process of moving to the offline storage ends.

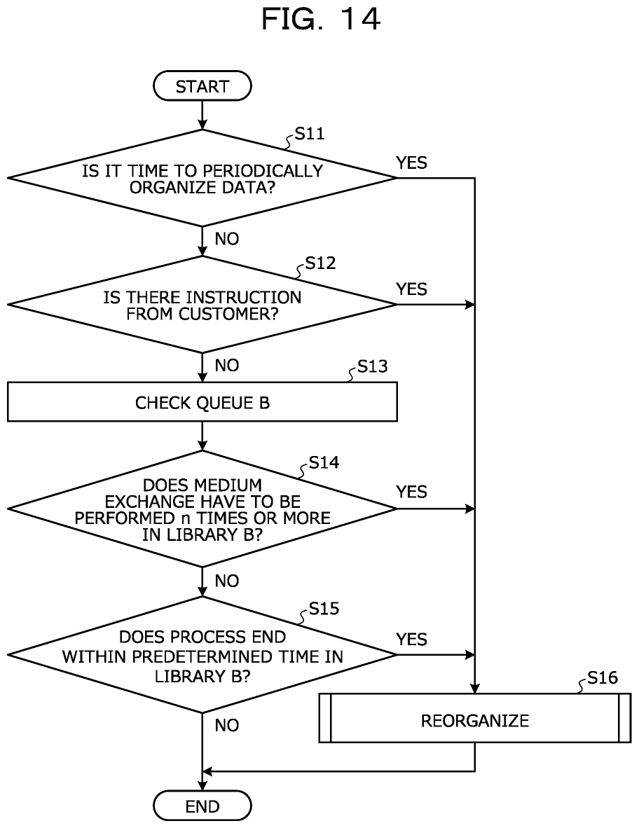

Next, a process of reorganizing data in the offline storage controller 1 illustrated in FIG. 6 will be described with reference to a flowchart (steps S11 to S16) illustrated in FIG. 14.

The offline storage controller B determines whether it is time to periodically organize data (step S11).

When it is time to periodically organize data (see the YES route in step S11), the process proceeds to step S16.

On the other hand, when it is not a time to periodically organize data (see the NO route in step S11), the offline storage controller B determines whether there is an instruction to reorganize data from the customer (step S12).

When there is the instruction from the customer (see the YES route in step S12), the process proceeds to step S16.

On the other hand, when there is no instruction from the customer (see the NO route in step S12), the offline storage controller B checks the queue B (step S13).

To read the contents of the queue B, the offline storage controller B determines whether the medium exchange (or replacement) of the tape 21 has to be performed n times or more in the library B (step S14).

When the medium exchange has to be performed n times or more in the library B (see the YES route in step S14), the process proceeds to step S16.

On the other hand, when the medium exchange does not have to be performed n times or more in the library B (see the NO route in step S14), the offline storage controller B determines whether the reorganizing process ends within a predetermined time in the library B (step S15).

When the reorganizing process ends within the predetermined time in the library B (see the YES route in step S15), the offline storage controller B executes the process of reorganizing (step S16). Then, the reorganizing process for data ends.

On the other hand, when the reorganizing process does not end within the predetermined time in the library B (see the NO route in step S15), the process of reorganizing data ends.

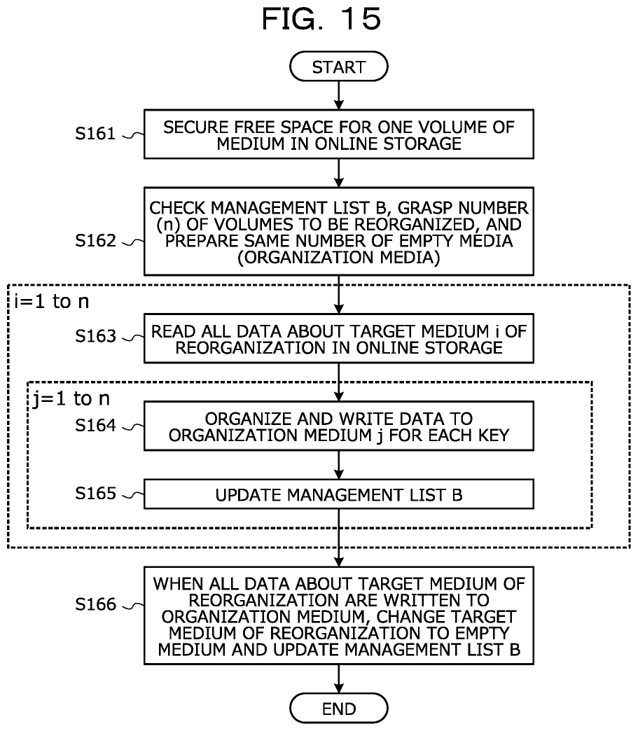

Next, a first detailed example of the reorganizing process for data in the offline storage controller 1 illustrated in FIG. 6 will be described with reference to a flowchart (steps S161 to S166) illustrated in FIG. 15.

The offline storage controller B causes the online storage unit 4 to secure a free space of the tape 21 for one volume of medium (step S161).

The offline storage controller B checks the management list B, grasps the number (n) of target volumes of the reorganizing process, and prepares the same number of empty media (organization media) (step S162).

The offline storage controller B causes the online storage unit 4 to read all data about a target medium i of the reorganizing process (step S163).

The offline storage controller B organizes and writes data to an organization medium j for each key (step S164).

The offline storage controller B updates the management list B (step S165).

Operations of steps S164 and S165 are repeatedly executed for j=1 to n, and operations of steps S163 to S165 are repeatedly executed for i=1 to n.

When all the data about the target medium of the reorganizing process are written to the organization medium, the offline storage controller B changes the target medium of the process of reorganizing to an empty medium and updates the management list B (step S166). Then, the first detailed example of the reorganizing process for data ends.

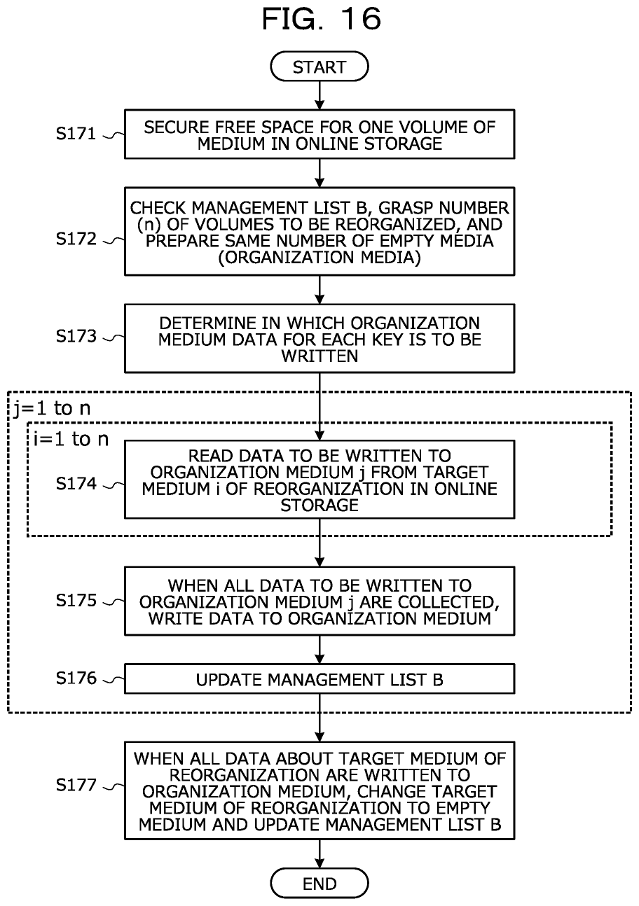

Next, a second detailed example of the reorganizing process for data in the offline storage controller 1 illustrated in FIG. 6 will be described with reference to a flowchart (steps S171 to S177) illustrated in FIG. 16.

The offline storage controller B causes the online storage unit 4 to secure a free space of the tape 21 for one volume of medium (step S171).

An offline storage controller B checks the management list B, grasps the number (n) of target volumes of the reorganizing process, and prepares the same number of empty media (organization media) (step S172).

The offline storage controller B determines in which organization medium the data for each key is to be written (step S173). At this time, the offline storage controller B may preferentially select a frequently used key or the like so that pieces of data having the frequently used key or the like are aggregated and written to the organization medium.

The offline storage controller B causes the online storage unit 4 to read the data to be written from the target medium i of the reorganizing process to the organization medium j (step S174).

The operation of step S174 is repeatedly executed for i=1 to n.

When all the data to be written to the organization medium j are collected, the offline storage controller B writes the data to the organization medium (step S175).

The offline storage controller B updates the management list B (step S176).

Operations of steps S174 to S176 are repeatedly executed for j=1 to n.

When all the data about the target medium of the reorganizing process are written to the organization medium, the offline storage controller B changes the target medium of the reorganizing process to an empty medium, and updates the management list B (step S177). Then, the second detailed example of the reorganizing process for data ends.

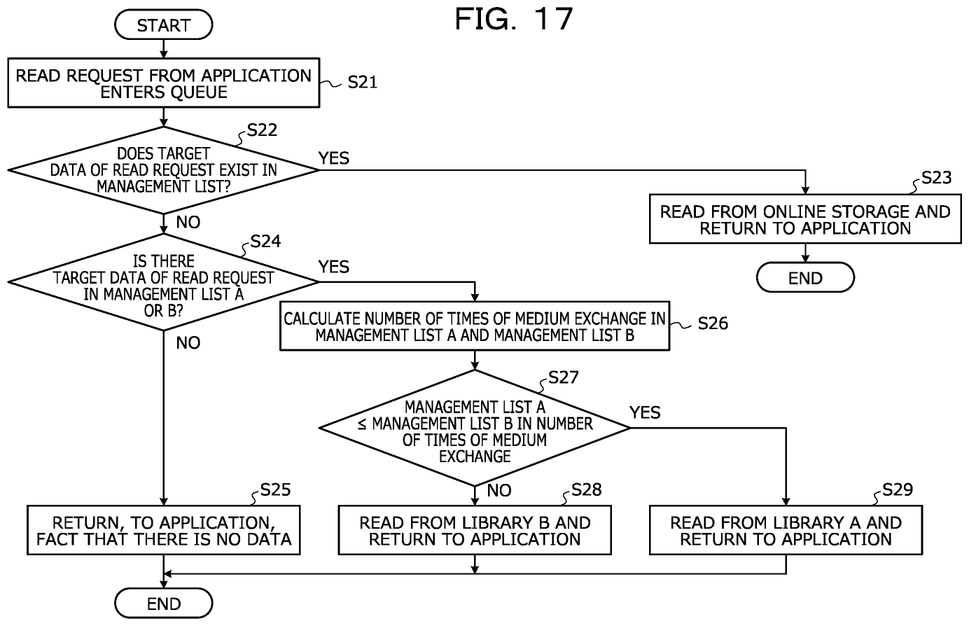

Next, a process of reading data in the offline storage controller 1 illustrated in FIG. 6 will be described with reference to a flowchart (steps S21 to S29) illustrated in FIG. 17.

The process of reading from the application 5 enters the queue 301 of the controller 3 (step S21).

The controller 3 determines whether or not target data of read request exists in the online storage management list 302 (step S22).

When the target data of read request exists in the online storage management list 302 (see the YES route in step S22), the controller 3 reads the data from the online storage unit 4 and returns the data to the application 5 (step S23). Then, the process of reading data ends.

On the other hand, when the target data of read request does not exist in the online storage management list 302 (see the NO route in step S22), the offline storage controllers A and B determine whether the target data of read request exists in the management list A or B (step S24).

When the target data of read request does not exist in the management lists A and B (see the NO route in step S24), the controller 3 returns, to the application 5, the fact that there is no target data of read request (step S25). Then, the process of reading data ends.

When the target data of read request is in the management list A or B (see the YES route in step S24), the offline storage controllers A and B refer to the management list A and the management list B and calculate the number of times of medium exchange of the tapes 21 in each of the libraries A and B (step S26).

The offline storage controllers A and B determine whether the management list A≤management list B in the number of times of medium exchange (step S27).

When the management list A>the management list B in the number of times of medium exchange (see the NO route in step S27), the offline storage controller B reads data from the library B and returns the data to the application 5 (step S28). Then, the process of reading data ends.

On the other hand, when the management list A management list B in the number of times of medium exchange (see the YES route in step S27), the offline storage controller A reads data from the library A and returns the data to the application 5. Then, the process of reading data ends.

### [C] Effects

According to the storage system 100, the offline storage controller 1, and the storage control method in one example of the embodiment described above, for example, the following operation effects may be obtained.

The online storage unit 4 stores data. The library 2 stores data that is stored in the online storage unit 4 and for which a certain period of time elapses. The offline storage controller 1 stores data in time series in the library 2, reads the time-series data at a predetermined timing, and reorganizes the read data for each key to store the reorganized data in the library 2 and read the reorganized data from the library 2 when data is read by the key.

Accordingly, the speed of the reading process may be increased. For example, it is possible to newly improve the speed of organizing reading by a key without changing the speed in the case of reading in chronological order. For example, while it takes 48*(5+2+1)=384 minutes to read data distributed to 48 tapes for four years, it may be shortened to 5+2+1*48=55 minutes in the embodiment.

The offline storage controller 1 temporarily copies all the time-series data from the tape 21 in the library 2 to the online storage unit 4 at the predetermined timing. The offline storage controller 1 reorganizes all the time-series data in the online storage unit 4 for each key to store the reorganized data in a new tape 21 in the library 2. In this way, the reorganizing process for data for each key on the tape 21 may be efficiently performed.

The offline storage controller 1 temporarily copies, from the tape 21 in the library 2 to the online storage unit 4, data to be stored on the new tape 21 in the library 2 among the time-series data, at the predetermined timing. The offline storage controller 1 reorganizes the data to be stored in the online storage unit 4 for each key to store the reorganized data on the new tape 21. In this way, the reorganizing process for data for each key on the tape 21 may be efficiently performed.

A predetermined timing is a timing at which a certain period of time elapses. In this way, the reorganizing process for data for each key on the tape 21 may be performed at an appropriate timing.

The predetermined timing is a timing at which, in the library 2 including the plurality of tapes 21, replacement of the plurality of tapes 21 with the drive 22 has to be performed a certain number of times or more. In this way, the reorganizing process for data for each key on the tape 21 may be performed at an appropriate timing.

When data to be read is not stored in the online storage unit 4, the offline storage controller 1 reads the data to be read from the library 2. In this way, the latest data stored in the online storage unit 4 is read from the online storage unit 4, and thus it is possible to further increase the speed of the reading process.

When the number of times of replacement of the tapes 21 with the drive 22 in the library A is equal to or less than the number of times of replacement of the tape 21 with the drive 22 in the library B, the offline storage controller A reads data from the library A. When the number of times of replacement of the tapes 21 with the drive 22 in the library A is greater than the number of times of replacement of the tape 21 with the drive 22 in the library B, the offline storage controller B reads data from the library B. In this way, it is possible to further increase the speed of the reading process on the data archived in the library 2. According to the second detailed example of the reorganizing process, it is possible to preferentially perform the organizing process on the data having a specific key, which makes it possible to further increase the speed of the reading process.

### [D] Others

The disclosed technique is not limited to the above-described embodiment. The disclosed technique may be carried out by variously modifying the technique without departing from the spirit of the present embodiment. Each of the configurations and each of the processes of the present embodiment may be selectively employed or omitted as desired or may be combined as appropriate.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A storage system that performs storage tiering, the storage system comprising:
a first storage device that stores data;
a second storage device that stores data that is stored in the first storage device and elapses for a predetermined period of time; and
a storage control device that stores data in time series in the second storage device, reads the time-series data at a predetermined timing, and reorganizes the read data for each key to store the reorganized data in the second storage device and read the reorganized data from the second storage device when the data is read by the key.

2. The storage system according to claim 1,
wherein the storage control device temporarily copies all the time-series data from a first recording medium in the second storage device to the first storage device at the predetermined timing and reorganizes all the time-series data in the first storage device for each key to store the reorganized data in a second recording medium in the second storage device.

3. The storage system according to claim 1,
wherein the storage control device temporarily copies data to be stored in a second recording medium in the second storage device among the time-series data from a first recording medium in the second storage device to the first storage device at the predetermined timing and reorganizes the data to be stored in the first storage device for each key to store the reorganized data in the second recording medium.

4. The storage system according to claim 1,
wherein the predetermined timing is a timing at which a predetermined period of time elapses.

5. The storage system according to claim 1,
wherein the second storage device includes a plurality of tape media, and
the predetermined timing is a timing at which replacement of the plurality of tape media with a drive device is required for a predetermined number of times or more in the second storage device.

6. The storage system according to claim 1,
wherein the storage control device reads data to be read from the second storage device when the data to be read is not stored in the first storage device.

7. The storage system according to claim 1,
wherein the storage control device includes a first storage control device and a second storage control device,
the second storage device includes a first tape medium device including a plurality of tape media in association with the first storage control device, and a second tape medium device including a plurality of tape media in association with the second storage control device,
the first storage control device reads data from the first tape medium device when the number of times of replacement of the plurality of tape media with a drive device in the first tape medium device is equal to or less than the number of times of replacement of the plurality of tape media with a drive device in the second tape medium device, and
the second storage control device reads data from the second tape medium device when the number of times of the replacement of the plurality of tape media with the drive device in the first tape medium device is greater than the number of times of the replacement of the plurality of tape media with the drive device in the second tape medium device.

8. A storage control device, to be coupled to a second storage device that stores data that is stored in a first storage device and elapses for a predetermined period of time, comprising:
a memory, and
a processor coupled to the memory and configured to:
store data in time series in the second storage device;
read the time-series data at a predetermined timing, and reorganizes the read data for each key to store the reorganized data in the second storage device; and
read the reorganized data from the second storage device when the data is read by the key

9. The storage control device according to claim 8, the processor is further configured to:
temporarily copy all the time-series data from a first recording medium in the second storage device to the first storage device at the predetermined timing and reorganizes all the time-series data in the first storage device for each key to store the reorganized data in a second recording medium in the second storage device.

10. The storage control device according to claim 8, the processor is further configured to:
temporarily copy data to be stored in a second recording medium in the second storage device among the time-series data from a first recording medium in the second storage device to the first storage device at the predetermined timing and reorganizes the data to be stored in the first storage device for each key to store the reorganized data in the second recording medium.

11. The storage control device according to claim 8,
wherein the predetermined timing is a timing at which a predetermined period of time elapses.

12. The storage control device according to claim 8,
wherein the second storage device includes a plurality of tape media, and
the predetermined timing is a timing at which replacement of the plurality of tape media with a drive device is required for a predetermined number of times or more in the second storage device.

13. The storage control device according to claim 8, the processor is further configured to:
read data to be read from the second storage device when the data to be read is not stored in the first storage device.

14. The storage control device according to claim 8, wherein
the second storage device includes a first tape medium device including a plurality of tape media in association with the storage control device, and a second tape medium device including a plurality of tape media in association with another second storage control device, and
the processor is further configured to:
reads data from the first tape medium device when the number of times of replacement of the plurality of tape media with a drive device in the first tape medium device is equal to or less than the number of times of replacement of the plurality of tape media with a drive device in the second tape medium device.

15. A storage control method for performing storage tiering, the storage control method comprising:
storing data in a first storage device;
storing data that is stored in the first storage device and elapses for a predetermined period of time in a second storage device; and
using a storage control device to store data in time series in the second storage device, read the time-series data at a predetermined timing, reorganize the read data for each key to store the reorganized data in the second storage device, and read the reorganized data from the second storage device when the data is read by the key.

16. The storage control method according to claim 15,
wherein the storage control device temporarily copies all the time-series data from a first recording medium in the second storage device to the first storage device at the predetermined timing and reorganizes all the time-series data in the first storage device for each key to store the reorganized data in a second recording medium in the second storage device.

17. The storage control method according to claim 15,
wherein the storage control device temporarily copies data to be stored in a second recording medium in the second storage device among the time-series data from a first recording medium in the second storage device to the first storage device at the predetermined timing and reorganizes the data to be stored in the first storage device for each key to store the reorganized data in the second recording medium.

18. The storage control method according to claim 15,
wherein the predetermined timing is a timing at which a predetermined period of time elapses.

19. The storage control method according to claim 15,
wherein the second storage device includes a plurality of tape media, and
the predetermined timing is a timing at which replacement of the plurality of tape media with a drive device is required for a predetermined number of times or more in the second storage device.

20. The storage control method according to claim 15,
wherein the storage control device reads data to be read from the second storage device when the data to be read is not stored in the first storage device.
